(19) United States
(12) Patent Application Publication
(10) Pub. No.: US 2026/0247500 A1
(43) Pub. Date: Aug. 20, 2026

(54) Adaptable Heating Element System for a Fluid Heater

(71) Applicant: Andrew Wing Shan Cheung, Beaufort, SC (US)

(72) Inventor: Andrew Wing Shan Cheung, Beaufort, SC (US)

(21) Appl. No.: 19/055,510

(22) Filed: Feb. 18, 2025

(51) Int. Cl. H05B 3/66; F24H 1/18; F24H 9/06

(52) U.S. Cl. CPC H05B 3/66; F24H 1/185; F24H 9/06

(57) ABSTRACT

An adaptable heating element system that allows one or/and a plurality of electrical heating element sections to grow in length, decrease in length, and/or turn orthogonally to account for various voltage sources, temperature ranges, fluids, tank dimensions, and tank compositions. The adaptable heating element system comprises at least one electrical heating element section comprising: at least one length of unit heating elements, at least one mid-span lug brace or type of end lug brace, and the structural support system. The structural support system comprises corresponding tank structure for the lug braces and the tank penetration means.

### BACKGROUND OF THE INVENTION

### Field of the invention

This invention relates to electrical heating elements in fluid heaters with a tank, and more specifically to a system of lugs, physical supporting structure of the system of lugs, and how the lugs are combined with electrical heating element lengths in fluid heaters to meet physical and electrical requirements of the fluid heaters. The fluid heaters themselves may be used for liquid or gases or both.

### Description of Related Art

Fluid heaters are used everywhere in domestic, commercial, and industrial applications. In modest domestic applications, a home water heater is relatively inexpensive and commonplace in modern times. Modern homes may use electricity or a fossil fuel. In commercial and industrial applications, heating a working fluid may also be accomplished by those same domestic energy sources; however, the volume of liquid to be heated is on a larger scale. Therefore, larger scale operations typically gravitate towards fossil fuel sources which are able to release a lot of heat in a short amount of time without deleteriously affecting the surrounding infrastructure of a facility.

The difference of scale necessitates different types of tanks, different types of heating elements, and different considerations. Additionally, commercial and industrial applications may have variation to what fluid is to be heated (presuming domestic applications are predominantly water heating), which also compounds the different considerations.

The round profile bent back on itself is a common heating element design in modern domestic water tanks. The weight of which is supported by a single hole attachment method to the tank and the scale of which ensures there is relatively little weight to be supported. Multiple elements may be installed at different locations of a tank to increase capacity. The single hole attachment method ensures ease of maintenance. Laperriere (U.S. Pat. No. 5,168,546), Ostrander (U.S. Pat. No. 2,660,657), Morris (U.S. Pat. No. 2,606,271), and Cunningham (U.S. Pat. No. 2,763,763) are among prior art indicating such attachment methods and heating element design. Examples of such heating elements are shown in FIGS. 1a and 1b.

Commercial and industrial applications require longer heating elements with multiple turns. The increased weight requires additional support within a tank or requires the heating element to be supported by an at least two hole attachment method. The necessary attachment method makes maintenance more complex because of the size of the heating element, resulting in increased costs to owners who may be private or public entities. Smalley (U.S. Pat. No. 1,762,701), Jones (U.S. Pat. No. 6,021,155), Leycuras (US Application No. 20040238526), and Wedge (U.S. Pat. No. 1,137,559) are among prior art indicating different heating elements in open systems with the two hole attachment method due to the increased size of the heating element. Frankel (U.S. Pat. No. 2,179,781) and Cohen (U.S. Pat. No. 1,420,693) are among prior art indicating different heating elements in closed systems. Other examples include hot plates (FIG. 1c), coils (FIG. 1d), and component heating elements forming circumferential patterns (FIG. 1e).

### SUMMARY OF THE INVENTION

Therefore, the objects of the present invention of an adaptable heating element system are 1) to decrease general maintenance costs, 2) to increase the life of existing infrastructure by decreasing the complexity of adaptability while still accounting for the variability inherent in different fluid heating applications, and 3) to give larger operations a more feasible option to use electrical heat sources instead of fossil fuels by utilizing a lower costing heating element system that may adapt to accommodate existing and future facility infrastructure.

In a preferred embodiment, the adaptable heating element system comprises at least one or a plurality of electrical heating element sections comprising: at least one or more lengths of unit heating elements, at least one mid-span lug brace or a type of end lug brace, and the corresponding structural support system. The corresponding structural support system includes but is not limited to the tank structure needed to physically support/attach/secure the lug braces and the tank penetration means (preferably the two hole method). The lengths of unit heating elements are attached to the lug braces which are in turn supported by corresponding tank structure. The tank penetration means allow electricity to pass from/through the wall of the tank structure in order to electrify the electrical heating element sections.

In another embodiment, the adaptable heating element system comprises at least lengths of unit heating elements, at least one mid-span lug brace, and corresponding tank structure for each mid-span lug brace, and tank penetration means.

In yet another embodiment, the adaptable heating element system comprises at least lengths of unit heating elements, at least one end lug brace, and corresponding tank structure for each end lug brace, and tank penetration means.

### BRIEF DESCRIPTION OF THE DRAWINGS

FIG. 1 is a depiction of various fluid heating elements.

FIG. 2 is an example of various shapes of lengths of unit heating elements

FIG. 3 is a depiction of a mid-span lug brace in the preferred embodiment.

FIG. 4a is a depiction of one type of end lug brace in the preferred embodiment.

FIG. 4b is a depiction of another type of end lug brace in the preferred embodiment.

FIG. 5 is a depiction of tank support structure for the lug braces in a preferred embodiment.

FIG. 6 is a depiction of various scenarios that the system may accommodate within a fluid heating tank whose internal structure is consistent between scenarios.

### DESCRIPTION

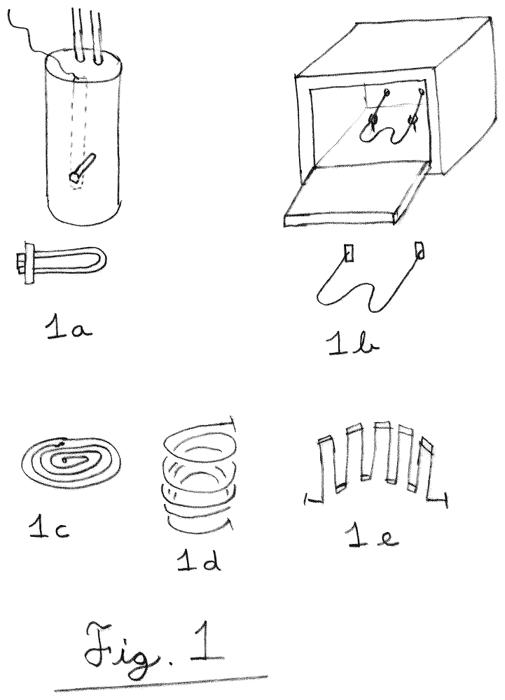

In a typical electrical domestic water heater (as shown in FIG. 1a), the fluid to be heated is water. The water enters a tank via an inlet pipe. A submerged electrical heating element attached to and through the side of the tank is electrified in order to dissipate heat to the incoming water. The heated water then passes through the tank to an outlet pipe toward wherever it is needed via opening of a faucet or showerhead, etc. Temperature control is typically maintained by an adjustable bimetallic switch.

In larger scale applications that include commercial and industrial uses, the operation of the fluid heater is predominantly the same as a domestic water heater but often times the fluid is for heat transfer and not necessarily end-use. The components may vary more in number, size, intricacies, and controls. Commercial and industrial uses also allow more variety of the fluid to be heated, such as water, oil, refrigerant, etc. Larger scale operations would have additional features such as additional heat exchangers, sensors, piping, seals, pumps, tank bracing, tank support, etc. Subsequently, the limits of voltage, phase changes, corrosion, temperature, and pressure are all dependent on any given application for any tank structure. The point being that regardless of the various features a small or large application may have, the embodiments of the present invention of an adaptable heating element system may accommodate the application variation.

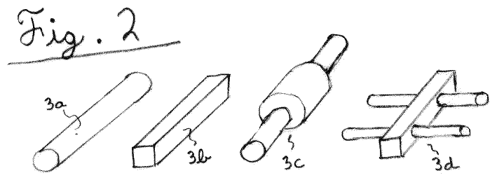

The heating element lengths may be made from gold, silver, copper, Inconel, carbon, nickel, cobalt, graphite, steel, molybdenum, and/or any other metal. The shape of the lengths of unit heating elements (as shown in FIG. 2) need only be conducive to be securely fastened to the lug braces within the tank. The heating element lengths are preferably all the same length per installation.

The lug braces themselves may be made out of ceramic, steel, copper, aluminum, nickel, cobalt, and/or any combination of applicable metals and/or metal alloys. Preferably, they are made of aluminum.

The tank may have any shape, height, width, length, diameter, and be made from any material, so long as it has accessible internal structure conducive to supporting the lugs and unit heating element lengths therein. This includes but is not limited to self-enclosed circular or self-enclosed rectangular tanks made up of common materials used to make fluid holding tanks.

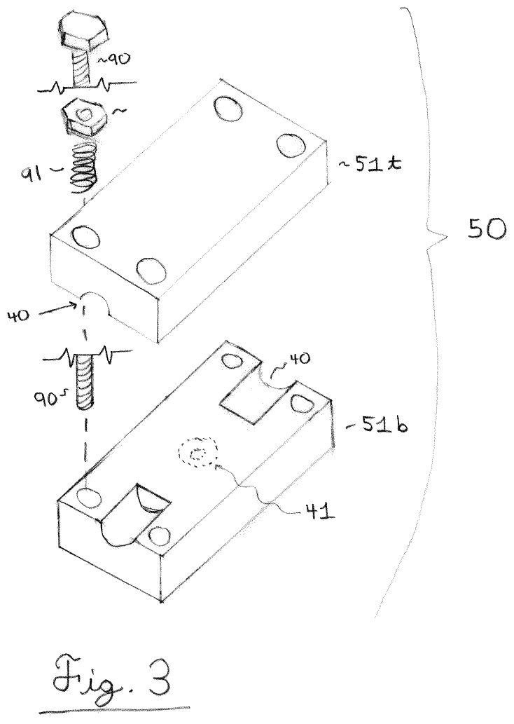

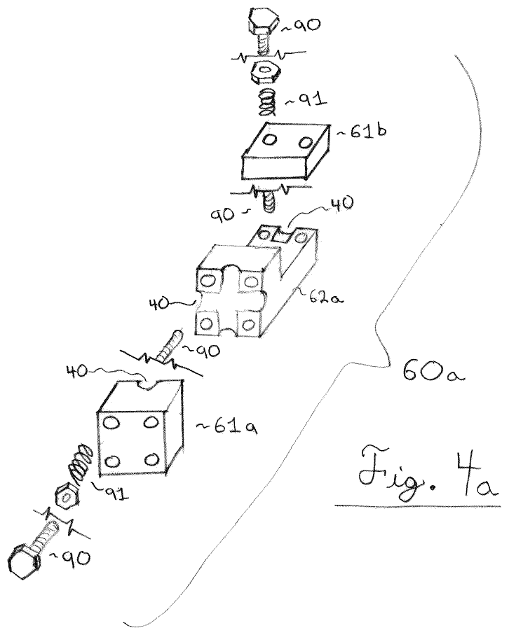

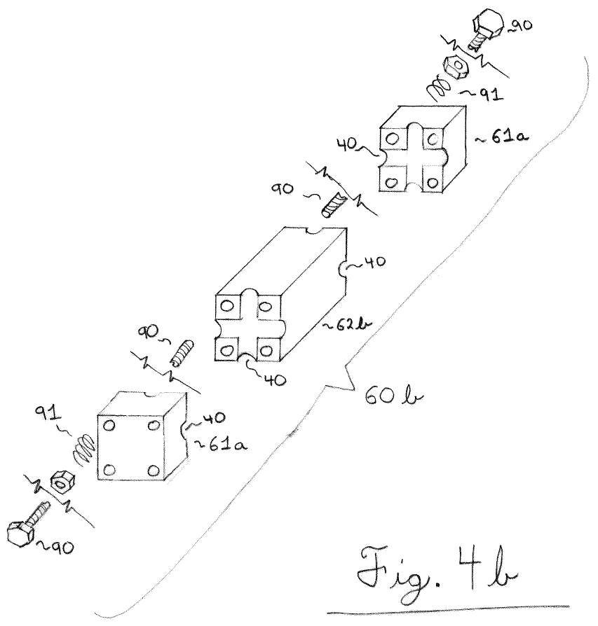

The preferred embodiment includes at least one type of end lug brace (as shown in FIG. 4a and FIG. 4b) and at least one mid-span brace (as shown in FIG. 3); however, other embodiments may have either one or a plurality of a type of end lug brace only, or may have either one or a plurality of mid-span braces only.

The preferred embodiment is envisioned to be predominantly applicable to closed systems but may be used in open systems in particular applications. The terms “closed systems” and “open systems” are used with respect to fluid and assume their meaning as is commonly known in the art of fluid heating.

The mid-span lug brace (50) has two mating bars (51t, 51b). The top and bottom mating bars are similar in length and shape and are made from similar materials. The bottom mating bar has holes that are preferably threaded and the top mating bar has holes that are preferably not threaded to allow for at least one threaded member (90) to pass through the top mating bar and be secured to the bottom mating bar. The threaded members are preferably made from the same material as the mating bars. The threaded members extend through the top mating bar and each have a spring or spring-like element (91) held in place by an adjustable nut or nuts. Preferably, both mating bars also have horizontal cutouts (40) in them on either side corresponding to receiving a unit heating element length. Alternatively, the mating bars may not have horizontal cutouts or either only the top or bottom mating bar has cutouts. The cutouts themselves may be of any shape and may or may not extend through the entirety of the mating bars. The bottom mating bar may additionally have a hole(s) or shaped cutout (41) to allow securing means to internal tank structure.

Each type of end lug brace (60a, 60b) has at least one clamp piece (61a, 61b) and a block piece (62a, 62b). In the preferred embodiment, there are two types of end lug braces, each having two clamp pieces. However, the two clamp pieces may be made as a single clamp piece. Referring to the preferred embodiment, the clamp pieces each have holes that allow threaded members to pass and are preferably unthreaded. Each threaded member(s) (90, FIGS. 4a and 4b may have multiple threaded members and associated elements), similar but not necessarily the same as those of the mid-span lug brace, also pass through a spring or spring-like element before an adjustable nut or nuts is/are attached to vary a force of the spring or spring-like element onto the clamp pieces. Each block piece contains corresponding holes that are preferably threaded for the threaded members of the clamp pieces, providing a securement means for the clamp pieces. The clamp and block pieces have cutouts (40) conducive to receiving a length of unit heating element. Each clamp piece preferably has one cutout which can be a compound shape (as shown in FIGS. 4a and 4b). Each block piece preferably has a cutout on one face and another cutout on another face, both of which may also be compound cutouts. In one type of block piece (FIG. 4a) the two block piece faces with cutouts are at right angles to each other. In another type of block piece (FIG. 4b) the two block piece faces with cutouts are on opposing ends of each other. Alternatively, the cutouts may only be on the block piece and not the clamp pieces or vice versa, and the cutouts may span the entire length of the block piece and/or clamp pieces or be shorter than the length of the block piece and/or clamp pieces. The preferred embodiment of the asymmetrical shaped type (FIG. 4a) and symmetrical shaped type (FIG. 4b) of end lug braces simplify the number of parts required to make any number of electrical heating element sections of various lengths and stages. Each block piece may also have additional features such as an additional cutout or hole to allow securement means to internal tank structure.

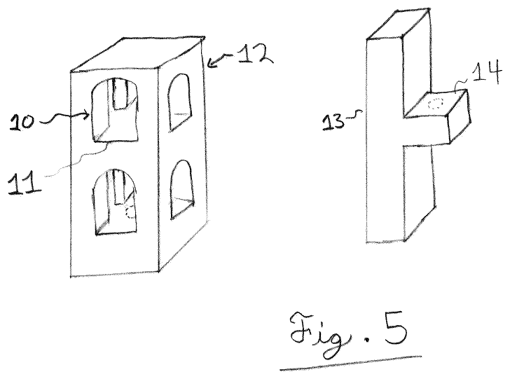

FIG. 5 depicts at least one attachment/securement method for the mid-span lug brace and types of end lug braces. The walls and internal pillars of the tank support the weights of the lugs and lengths of unit heating elements. Although the entirety of a tank is not shown in FIG. 5, the tank itself may contain a plurality of pillars, columns, or supports that have surfaces to hold up the lug braces. The tank walls may also have surfaces to hold up the lug braces as well. The lugs may or may not be physically secured to the internal tank structure. However, the nature of the system itself means that a larger tank may have many supports, but does not necessarily mean that all of the supports are used. In other words, the use of the lugs and the lengths allows dynamic alteration of the length of the overall heating element which in turn effects capacity and accommodates varying materials, voltages, and heating capacities. Additionally, the securement method of the lengths of heating elements to the lugs allows partial replacement, extending the life of a tank and reducing maintenance costs.

### EXAMPLE

Once a tank has been fabricated taking into account all future and present considerations of a facility, the lug braces would be installed in the tank. Once installed, the lengths of unit heating elements would be installed onto the lug braces. Thereafter, each end of the heating element assembly is connected to a conduction means that passes through a wall of the tank, provided that the penetration(s) is/are sealed and allow(s) for electrical connection. The conduction means engages a length of unit heating element which in turn is then secured to either a mid-span lug brace or a type of end lug brace. The number of mid-span lug braces may vary with the dimensions of a tank; however, any straight line of lugs, conduction means, and unit heating lengths will eventually end with another conducting means or an end lug brace.

In other words, the heating element assembly may have one or a plurality of electrical heating element sections. Each electrical heating element section is a generally straight assembly of lug braces and lengths of unit heating elements. Each end of each electrical heating element section starts and ends at either a lug brace or conduction means.

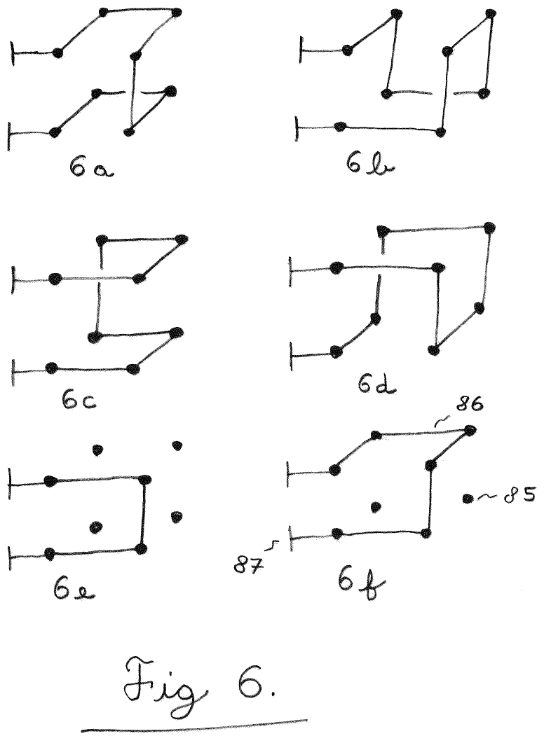

An end lug brace changes the direction of the next electrical heating element section. The overall adaptability of the system to form any shape consisting of orthogonal lines is only limited by the internal structure of the tank (not external penetrations and external seals). Such adaptability allows the system to establish “hot spot areas” anywhere within in the tank (including the center area, a side area, the top area, the bottom area, multiple specific areas, etc.) as shown in FIG. 6. The preferred embodiment would have the lengths of unit heating elements of the heating element assembly evenly distributed in the bottom area of a tank while allowing the assembly to have multiple connected tiers inside the tank. The preferred embodiment is not limited to but could be submerged in liquid or reside in a gaseous only fluid tank.

In greater detail, FIG. 6 shows schematic orientations of the adaptable heating element system of the present invention and helps to define the “adaptability” of the “adaptable” heating element system. The nodes (85) indicate surfaces of support structure for lug braces, while the lines indicate lengths of unit heating elements (86). Penetration means is represented by the sideways T symbol (87). FIGS. 6a, 6b, 6c, and 6d indicate different orientations to use all of the support surfaces. FIGS. 6e and 6f indicate partial use of the support surfaces which may be a result of a variety of factors. However, the point of emphasis is that the tank's internal support structure does not have to change even though the lug brace types and orientations might, reducing maintenance/replacement costs and increasing the lifespan of the tank.

Various methods exist on making such a sealed connection with applicable materials as noted in the related arts and background of the invention. However, additional attachment methods include fabricating a conductive member into the walls of the tank or installing a sealed sleeve to allow a conductive member to pass through to the heating element assembly. The working voltages of the conductors would be dictated by the transformer or transformers that feed the conductors leading into the tank. It is noteworthy that the transformer itself may also run to yet another transformer depending on the specific limitations of any particular application.

If electrical infrastructure improvements and upgrades necessitate any change in the heating element, the preferred embodiment is able to be manually adapted in piece-meal fashion to increase or decrease in overall length or even have a combination of lengths of unit heating elements of various shapes and materials in the same electrical heating element section, resulting in a segmented or even distribution that provides a modified capacity while maintaining the same electrical contact points to the tank as originally designed. The design of the lug braces and tank support structure of the lug braces in the tank accommodate inherent characteristics of whatever materials are selected.

The sealing and conduction means may be one of numerous common methods known in the art. Swanson (U.S. Pat. No. 4,498,692) is one such piece of prior art that teaches a mechanical seal with multiple sealing components for a conduit of sorts. The sealing means for the present invention may be, but is not limited to, a gasket sandwiched between flanged connections or an electrically isolated conductor embedded within the wall of the fluid heater. The conduction means for the present invention may be, but is not limited to, an electrically isolated conductor embedded within the wall of the fluid heater or may be a conductor that is electrically isolated from the fluid heater and passes through an opening in the fluid heater from the outside of the tank to the inside of the tank. The opening may be sealed by the sealing means on one side or both sides of the tank. The sealing means, the conduction means, and/or the opening in the fluid heater together define the tank penetration means.

### KEY FOR FIGURES

1a, 1b—tank
3—lengths of unit heating elements
50—Mid-span lug brace
60a, 60b—End lug brace
51t, 51b—Mating bars
61a, 61b—Clamp piece
62a, 62b—block piece
70—Threaded holes
80—Holes
90—Threaded member
91—Spring, spring like element
92—Nut
40—Cutouts
41—Bottom bar hole/cutout
10—pillars
12—columns
11—surfaces
13—tank walls
14—surfaces

1. An adaptable heating element system comprising:
One or a plurality of separate lengths of unit heating elements, and
At least one or a plurality of at least one type of end lug brace or a mid-span lug brace.

2. The adaptable heating element system of claim 1, wherein the at least one type of end lug brace has
a first securement means for at least one length of a heating element unit.

3. The adaptable heating element system of claim 1, wherein the at least one mid-span lug brace has a
second securement means for at least one length of a heating element unit.

4. The adaptable heating element system of claim 2, wherein the at least one mid-span lug brace has a
second securement means for at least one length of a heating element unit.

5. The adaptable heating element system of claim 2, wherein the at least one type of end lug brace is
asymmetrical.

6. The adaptable heating element system of claim 4, wherein the first securement means and the second
securement means comprise at least one spring means.

7. The adaptable heating element system of claim 1, wherein each end lug brace and the mid-span lug
brace have at least a securing means to restrict at least one degree of freedom.

8. The adaptable heating element system of claim 2, wherein the first securement means holds two
separate lengths of the unit heating elements.

9. The adaptable heating element system of claim 3, wherein the second securement means holds two
separate lengths of the heating element unit.

10. The adaptable heating element system of claim 1, wherein each separate end lug brace of any type
of end lug brace, each separate mid-span lug brace, and each separate length of the unit heating
elements may be made of different materials than an other end lug brace of any type of end lug brace, an other of mid-span lug brace, and an other of length of the unit heating elements, respectively.

11. The adaptable heating element system of claim 10, wherein the securing means is an aperture for a
fastener.

12. The adaptable heating element system of claim 1, wherein the adaptable heating element system
and components are submergible.

13. A method of heating a fluid using an adaptable heating element system in a fluid heating tank.

14. The method of claim 13, wherein the method of heating the fluid comprises:
Supporting at least one of a mid-span lug brace or a type of end lug brace of the adaptable
heating element system in a heating fluid tank using a structural support system in a fluid heating tank;
Connecting at least one length of unit heating element to at least one of either the mid-span lug
brace or the type of end lug brace of the adaptable heating element system in the heating fluid tank to form an heating element assembly; and
Connecting the heating element assembly to a tank penetration means.

15. The method of claim 13, wherein the structural support system comprises one or a plurality of
vertical supports within a space for holding fluid in the fluid heating tank.

16. The method of claim 13, wherein the structural support system comprises one or a plurality of
vertical supports, integral to the fluid heating tank, within a space for holding fluid in the
fluid heating tank.

17. The method of claim 13, wherein the structural support system is used in a mass closed system.

18. The method of claim 13, wherein the fluid to be heated in the fluid heating tank by the adaptable
heating element system remains in the fluid heating tank.

19. An adaptable heating element system, for use in a fluid heating tank, comprising:
at least one electrical heating element section comprising:
at least one length of unit heating elements,
at least one mid-span lug brace or type of end lug brace,
and a structural support system comprising:
structure in the fluid heating tank that supports each mid-span lug brace and
each end lug brace of any type of end lug brace,
and tank penetration means.

20. The adaptable heating element system of claim 19, wherein the fluid heating tank is a mass closed
system.
